(19) United States
(12) Patent Application Publication
(10) Pub. No.: US 2025/0357543 A1
(43) Pub. Date: Nov. 20, 2025

(54) ELECTROLYTES INCLUDING FLUORINATED ORGANIC SOLVENT MIXTURES FOR BATTERIES INCLUDING HIGH-VOLTAGE POSITIVE ELECTRODE MATERIALS AND BATTERIES INCLUDING THE SAME

(71) Applicant: GM GLOBAL TECHNOLOGY OPERATIONS LLC, Detroit, MI (US)

(72) Inventors: Vamakshi YADAV, Sterling Heights, MI (US); Hasnain HAFIZ, Troy, MI (US); Lei WANG, Rochester Hills, MI (US)

(21) Appl. No.: 18/664,879

(22) Filed: May 15, 2024

(51) Int. Cl. H01M 10/0569; H01M 4/02; H01M 4/36; H01M 4/505; H01M 10/0525

(52) U.S. Cl. CPC H01M 10/0569; H01M 4/366; H01M 4/505; H01M 10/0525; H01M 2004/028; H01M 2300/0034; H01M 2300/004

(57) ABSTRACT

A battery that cycles lithium ions includes a positive electrode and an electrolyte infiltrating the positive electrode. The electrolyte includes an organic solvent and a lithium salt. The organic solvent includes a fluorinated ester, a fluorinated ether, and a fluorinated carbonate. A volumetric ratio of the fluorinated ester to the fluorinated ether in the organic solvent is greater than or equal to 1:3 and less than or equal to 3:1. A volumetric ratio of the fluorinated carbonate to the combined amount of the fluorinated ester and the fluorinated ether in the organic solvent is greater than or equal to 0.9:4 and less than or equal to 1.1:4.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to electrolytes including fluorinated organic solvent mixtures for batteries that include high-voltage electroactive positive electrode materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit certain desirable properties including high ionic conductivity, high salt solvability, a wide electrochemical stability window, ability to form a stable ionically conductive solid electrolyte interphase on surfaces of the positive electrode and/or the negative electrode, and chemical compatibility with other components of the batteries.

### SUMMARY

A battery that cycles lithium ions, in accordance with one or more embodiments of the present disclosure, comprises a positive electrode and an electrolyte infiltrating the positive electrode. The positive electrode comprises an electroactive positive electrode material. The electrolyte comprises an organic solvent and a lithium salt in the organic solvent. The organic solvent comprises a fluorinated ester, a fluorinated ether, and a fluorinated carbonate. A volumetric ratio of the fluorinated ester to the fluorinated ether in the organic solvent is greater than or equal to 1:3 and less than or equal to 3:1. A volumetric ratio of the fluorinated carbonate to the combined amount of the fluorinated ester and the fluorinated ether in the organic solvent is greater than or equal to 0.9:4 and less than or equal to 1.1:4.

In aspects, the electroactive positive electrode material may comprise a layered lithium transition metal oxide having an upper cutoff potential of greater than or equal to 4.3 Volts versus Li⁺/Li.

The fluorinated ester may have the formula (1):

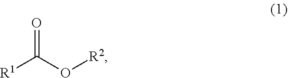

where R¹ and R² are each individually a fluorinated or nonfluorinated C₁-C₃ straight-chain alkyl, and where at least one of R¹ and R² is a polyfluorinated ethyl.

In aspects, the fluorinated ester may comprise 2,2,2-trifluoroethyl acetate (TFEA), methyl pentafluoropropionate (MPFP), methyl 3,3,3-trifluoropropionate (MTFP), 2,2,2-trifluoroethyl butyrate (TFEB), or a combination thereof.

The fluorinated ether may have the formula (2):

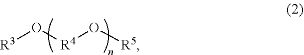

where R³ and R⁵ are each individually a fluorinated or nonfluorinated C₁-C₆ straight-chain or branched-chain alkyl; n is 0 or 1; R⁴ is a fluorinated or nonfluorinated C₁-C₄ straight-chain alkylene; and where at least one of R³, R⁴, or R⁵ is polyfluorinated.

In aspects, the fluorinated ether may comprise 1,1,2,2-tetrafluoroethyl-2,2,3,3-tetrafluoropropylether (TTE); 1,2-bis(1,1,2,2-tetrafluoroethoxy) ethane (TFE); 2,2,3,3-tetrafluoro-1,4-dimethoxybutane (FDMB); 2-trifluoro-2-fluoro-3-difluoropropoxy-3-difluoro-4-fluoro-5-trifluoropentane (TPTP); 2-trifluoromethyl-3-methoxyperfluoropentane (TMMP); methyl perfluorobutyl ether (MFE); or a combination thereof.

The fluorinated carbonate may comprise fluoroethylene carbonate (FEC); difluoroethylene carbonate (DFEC); bis(2,2,2-trifluoroethyl) carbonate (BFEC); methyl-2,2,2-trifluoroethyl carbonate (FEMC); or a combination thereof.

The fluorinated ester may constitute, by volume, greater than 5% and less than or equal to 60% of the organic solvent, the fluorinated ether may constitute, by volume, greater than 5% and less than or equal to 60% of the organic solvent, and the fluorinated carbonate may constitute, by volume, greater than 5% and less than or equal to 40% of the organic solvent.

A volumetric ratio of the fluorinated ester to the fluorinated ether in the organic solvent may be greater than or equal to 1:1.5 and less than or equal to 1.5:1.

In aspects, the fluorinated ester may comprise 2,2,2-trifluoroethyl acetate (TFEA), the fluorinated ether may comprise 1,1,2,2-tetrafluoroethyl-2,2,3,3-tetrafluoropropylether (TTE), and the fluorinated carbonate may comprise fluoroethylene carbonate (FEC).

The electrolyte may be substantially free of non-fluorinated organic carbonates.

The lithium salt may comprise lithium hexafluorophosphate (LiPF₆), lithium difluorophosphate (LiPO₂F₂), lithium perchlorate (LiClO₄), lithium tetrafluoroborate (LiBF₄), lithium hexafluoroarsenate (LiAsF₆), lithium bis(trifluoromethanesulfonyl)imide) (LiTFSI), lithium bis(fluorosulfonyl)imide (LiFSI), lithium bis(oxalato) borate (LiBOB), lithium difluoro (oxalato) borate (LiDFOB), or a combination thereof.

The electroactive positive electrode material may comprise a layered lithium-rich and manganese-based transition metal oxide represented by the formula Li₁₊ₓMe₁₋ₓO₂, wherein 0<x≤0.33, wherein Me comprises at least one transition metal, and wherein Me comprises, on an atomic basis, greater than 50% manganese (Mn), and wherein the electroactive positive electrode material has an upper cutoff potential of greater than or equal to 4.6 Volts versus Li⁺/Li.

The layered lithium-rich and manganese-based transition metal oxide may constitute, by weight, greater than or equal to 90% of the positive electrode.

A battery that cycles lithium ions, ions, in accordance with one or more embodiments of the present disclosure, comprises a negative electrode, a positive electrode spaced apart from the negative electrode, and an electrolyte in ion ionic communication with the negative electrode and the positive electrode. The negative electrode comprises an electroactive negative electrode material. The positive electrode comprises an electroactive positive electrode material comprising a layered lithium-rich and manganese-based transition metal oxide represented by the formula Li₁₊ₓMe₁₋ₓO₂, wherein 0<x≤0.33, wherein Me comprises at least one transition metal, and wherein Me comprises, on an atomic basis, greater than 50% manganese (Mn). The electrolyte comprises an organic solvent and a lithium salt in the organic solvent. The organic solvent comprises a fluorinated ester, a fluorinated ether, and a fluorinated carbonate. A volumetric ratio of the fluorinated ester to the fluorinated ether in the organic solvent is greater than or equal to 1:3 and less than or equal to 3:1. A volumetric ratio of the fluorinated carbonate to the combined amount of the fluorinated ester and the fluorinated ether in the organic solvent is greater than or equal to 0.9:4 and less than or equal to 1.1:4. The electrolyte is substantially free of non-fluorinated organic carbonates.

The fluorinated ester may comprise 2,2,2-trifluoroethyl acetate (TFEA), methyl pentafluoropropionate (MPFP), methyl 3,3,3-trifluoropropionate (MTFP), 2,2,2-trifluoroethyl butyrate (TFEB), or a combination thereof. The fluorinated ether may comprise 1,1,2,2-tetrafluoroethyl-2,2,3,3-tetrafluoropropylether (TTE); 1,2-bis(1,1,2,2-tetrafluoroethoxy) ethane (TFE); 2,2,3,3-tetrafluoro-1,4-dimethoxybutane (FDMB); 2-trifluoro-2-fluoro-3-difluoropropoxy-3-difluoro-4-fluoro-5-trifluoropentane (TPTP); 2-trifluoromethyl-3-methoxyperfluoropentane (TMMP); methyl perfluorobutyl ether (MFE); or a combination thereof. The fluorinated carbonate may comprise fluoroethylene carbonate (FEC); difluoroethylene carbonate (DFEC); bis(2,2,2-trifluoroethyl) carbonate (BFEC); methyl-2,2,2-trifluoroethyl carbonate (FEMC); or a combination thereof.

A volumetric ratio of the fluorinated ester to the fluorinated ether in the organic solvent may be greater than or equal to 1:1.5 and less than or equal to 1.5:1.

The fluorinated ester may constitute, by volume, greater than 5% and less than or equal to 60% of the organic solvent, the fluorinated ether may constitute, by volume, greater than 5% and less than or equal to 60% of the organic solvent, and the fluorinated carbonate may constitute, by volume, greater than 5% and less than or equal to 40% of the organic solvent.

The layered lithium-rich and manganese-based transition metal oxide may have an upper cutoff potential of greater than or equal to 4.6 Volts versus Li⁺/Li, and the electrolyte may be chemically stable at operating potentials of greater than or equal to 4.6 Volts versus Li⁺/Li.

The electroactive positive electrode material may constitute, by weight, greater than or equal to 90% of the positive electrode.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive electrode, the porous separator, and optionally the negative electrode.

In the drawings, reference numbers may be reused to identify similar and/or identical elements.

### DETAILED DESCRIPTION

The presently disclosed electrolytes are formulated to have a relatively wide electrochemical stability window and thus can be used in batteries that cycle lithium ions to help improve the cycling stability thereof at relatively low cost. Such electrolytes may be used in batteries that cycle lithium ions and that operate at upper cutoff potentials of less than or equal to 4.2 Volts (V) versus Li⁺/Li. Due to the relatively wide electrochemical stability window of the presently disclosed electrolytes, use of such electrolytes may be particularly beneficial in batteries that include high-voltage electroactive positive electrode materials and operate at upper cutoff potentials of greater than or equal to 4.3 V. In aspects, the presently disclosed electrolytes are formulated for use in batteries that cycle lithium ions and include lithium-rich and manganese-based oxides as high-voltage electroactive positive electrode materials.

The presently disclosed electrolytes include an organic solvent comprising a mixture of a fluorinated ester, a fluorinated ether, and a fluorinated carbonate, wherein the fluorinated carbonate constitutes, by volume, less than or equal to 40% of the organic solvent. Unlike electrolytes that primarily include non-fluorinated carbonates as organic solvents (e.g., electrolytes that include, by volume, greater than 50% non-fluorinated carbonates), the presently disclosed electrolytes are chemically stable at high oxidation potentials (e.g., at potentials of greater than or equal to 4.3 V, optionally greater than or equal to 4.4 V, optionally greater than or equal to 4.6 V, optionally greater than or equal to 4.8 V, or optionally greater than or equal to 5 V) and thus can be used in batteries that operate at high upper cutoff potentials to provide the batteries with high capacity retention and high coulombic efficiency, while minimizing or eliminating gas generation during cycling. In addition, the presently disclosed electrolytes can be used in batteries that operate at high upper cutoff potentials as a substitute for electrolytes that primarily include fluorinated carbonates as organic solvents (e.g., electrolytes that include, by volume, greater than 50% fluorinated carbonates) to provide the batteries with comparable capacity retention and coulombic efficiency, at relatively low cost. In addition, in comparison to electrolytes that primarily include fluorinated carbonates as organic solvents, the presently disclosed electrolytes have relatively high ionic conductivities, and thus can be used in batteries that cycle lithium ions to improve the electrochemical performance and rate capability thereof.

Unless expressed stated otherwise, all potentials (voltages) stated herein are versus Li/Li⁺.

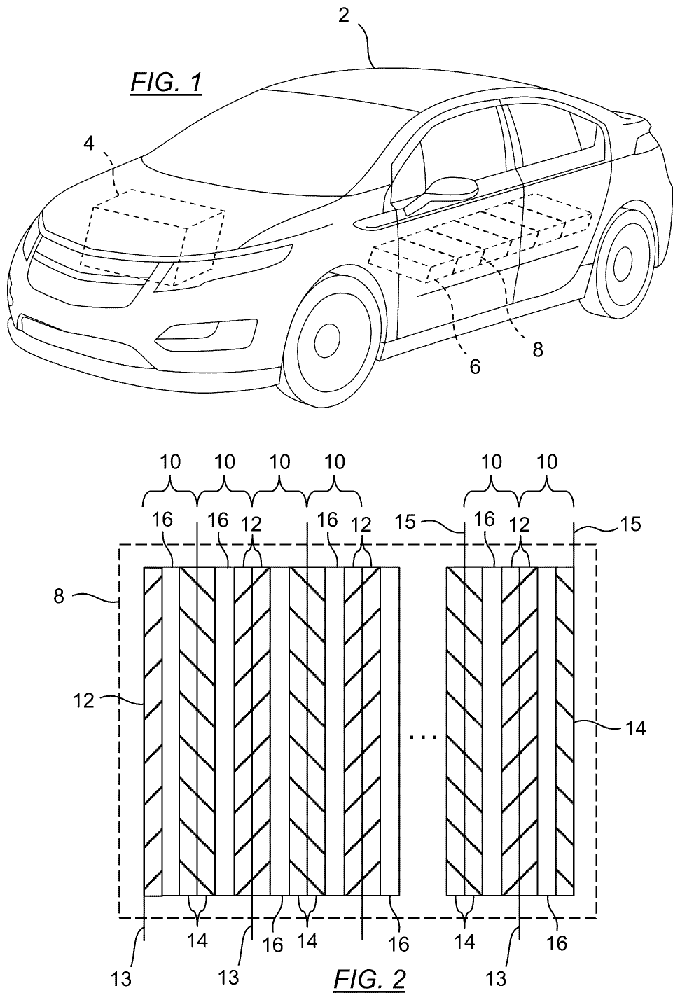

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

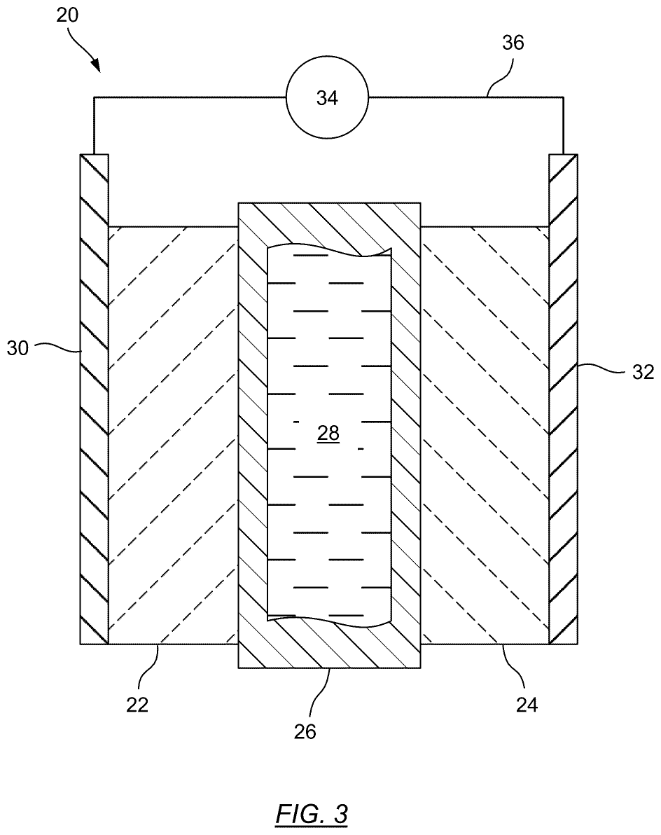

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The positive electrode 24 is formulated to store and release lithium ions during discharge and charge of the battery 20. The positive electrode 24 may be in the form of a continuous porous layer disposed on the major surface of the positive electrode current t collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium at a higher electrochemical potential than the electroactive material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). The electroactive material of the positive electrode 24 may constitute, by weight, greater than or equal to 50%, optionally greater than or equal to 60%, optionally greater than or equal to 70%, or optionally greater than or equal to 90%, and less than or equal to 97% of the positive electrode 24.

In embodiments, the electroactive material of the positive electrode 24 may be a “high-voltage” electroactive material and may have an upper cutoff potential of greater than or equal to 4.3 V, optionally greater than or equal to 4.4 V, optionally greater than or equal to 4.6 V, or optionally greater than or equal to 4.8 V, and less than or equal to 5 V versus Li⁺/Li. In aspects, the electroactive material of the positive electrode 24 may comprise a layered lithium-rich and manganese-based transition metal oxide represented by the formula Li₁₊ₓMe₁₋ₓO₂, where 0<x≤0.33 and where Me comprises, on an atomic basis, greater than or equal to about 50% manganese (Mn), or optionally greater than or equal to 60% Mn, and less than or equal to 100% Mn, or optionally less than or equal to 70% Mn. In embodiments, Me may comprise Mn, Ni, and Co. In other embodiments, Me may comprise Mn and Ni. Such layered lithium-rich and manganese-based transition metal oxide may have an operating potential of at least 4.6 V versus Li⁺/Li.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to about 1%, or optionally greater than or equal to about 5%, and less than or equal to about 10% of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to about 1%, or optionally greater than or equal to about 5% and less than or equal to about 10% of the positive electrode 24.

The negative electrode 22 is formulated to store and release lithium ions to facilitate charge and discharge, respectively, of the battery 20. The negative electrode 22 may be in the form of a continuous layer of material disposed on a major surface of the negative electrode current collector 30. The negative electrode 22 comprises an electroactive material (electroactive negative electrode material) that can store and release lithium ions by undergoing a reversible redox reaction with lithium during charge and discharge of the battery 20. Examples of electroactive negative electrode materials include lithium, lithium-based materials (e.g., alloys of lithium and silicon, aluminum, indium, and/or tin), carbon (e.g., graphite, activated carbon, carbon black, hard carbon, soft carbon, and/or graphene), carbon-based materials, silicon, silicon-based materials (e.g., alloys of silicon and lithium, tin, iron, aluminum, and/or cobalt), silicon oxide, silicon oxide-based materials (e.g., lithium silicon oxide), tin oxide, aluminum, indium, zinc, germanium, titanium oxide, lithium titanate, and combinations thereof. The electroactive material of the negative electrode 22 may constitute, by weight, greater than or equal to about 50%, optionally greater than or equal to about 60%, or optionally greater than or equal to about 70% and less than or equal to about 97%, optionally less than or equal to about 90%, or optionally less than or equal to about 80% of the negative electrode 22.

In embodiments, the electroactive material of the negative electrode 22 may comprise a silicon oxide-based material (e.g., Si, SiOₓ, and/or Li_{y}SiOₓ) and a carbon-based material (e.g., graphite). In such case, the silicon oxide-based material may constitute, by weight, greater than or equal to 10% and less than or equal to 70%, or optionally less than or equal to 30% of the electroactive material of the negative electrode 22 and the carbon-based material (e.g., graphite) may constitute, by weight, greater than or equal to 30%, or optionally greater than or equal to 70% and less than or equal to 90% of the electroactive material of the negative electrode 22.

In embodiments, the negative electrode 22 may be porous and the electroactive material of the negative electrode 22 may be a particulate material. In embodiments where the electroactive material of the negative electrode 22 is a particulate material, particles of the electroactive material of the negative electrode 22 may be intermingled with a polymer binder and optionally an electrically conductive material. The same polymer binders and/or electrically conductive materials disclosed above with respect to the positive electrode 24 may be used in the negative electrode 22 in substantially the same amounts. In other embodiments, the electroactive material of the negative electrode 22 may consist of lithium and the negative electrode 22 may be in the form of a nonporous metal film or foil, such as a lithium metal film or lithium metal foil. In such case, the negative electrode 22 may comprise, by weight, greater than 97% lithium, or optionally greater than 99% lithium. In embodiments where the electroactive material of the negative electrode 22 consists of lithium, the negative electrode 22 may be substantially free of elements or compounds that undergo a reversible redox reaction with lithium during operation of the battery 20. In addition, in such embodiments, the negative electrode 22 may be substantially free of a polymer binder.

The separator 26 physically separates and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer. Examples of polymers for the separator 26 include polyolefins (e.g., polyethylene, PE, and/or polypropylene, PP), polyamide (PA), poly(tetrafluoroethylene) (PTFE), polyvinylidene fluoride (PVDF), poly(vinyl chloride) (PVC), and combinations thereof. In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂).

The electrolyte 28 is ionically conductive and provides a medium for the conduction of lithium ions between the negative electrode 22 and the positive electrode 24. The electrolyte 28 comprises an organic solvent and a lithium salt in the organic solvent.

The organic solvent is formulated to provide the electrolyte 28 with chemical stability at a wide range of operating potentials. For example, the organic solvent may be formulated to provide the electrolyte 28 with chemical stability at operating potentials of greater than or equal to 4.3 V, optionally greater than or equal to 4.4 V, optionally greater than or equal to 4.6 V, optionally greater than or equal to 4.8 V, or optionally greater than or equal to 5 V versus Li⁺/Li. Chemical stability of the electrolyte 28 means that, at the aforementioned operating potentials, the electrolyte 28 does not undergo a chemical reaction that materially or substantially degrades the function of the electrolyte 28 in the battery 20. Chemical reactions that materially or substantially degrade the function of the electrolyte 28 in the battery 20 may be chemical reactions that lower the ionic conductivity of the electrolyte 28 by more than 5% or increase the internal resistance of the battery 20 by more than 5% per 100 cycles of the battery 20.

The organic solvent comprises a fluorinated ester, a fluorinated ether, and a fluorinated carbonate. The organic solvent may constitute, by weight, greater than or equal to 80%, or optionally greater than or equal to 85%, and less than or equal to 95%, or optionally less than or equal to 90% of the electrolyte 28. In embodiments, the fluorinated ester, the fluorinated ether, and the fluorinated carbonate may constitute greater than or equal to 80%, optionally greater than or equal to 90%, optionally greater than or equal to 95%, optionally greater than or equal to 98%, or optionally 100% of the organic solvent.

The fluorinated ester is formulated to have exceptional electrochemical stability at high oxidation potentials (e.g., at potentials of greater than or equal to 4.6 V), good chemical compatibility with the electroactive material of the positive electrode 24, and to provide the electrolyte 28 with high ionic conductivity. The fluorinated ester has the formula (1):

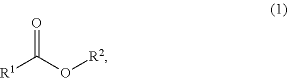

where R¹ and R² are each individually a fluorinated or nonfluorinated C₁-C₃ straight-chain alkyl, and where at least one of R¹ and R² is a polyfluorinated ethyl (e.g., a perfluorinated ethyl). In aspects, R¹ and/or R² each individually may be methyl, ethyl, n-propyl, trifluoroethyl, or pentafluorethyl.

In embodiments, the fluorinated ester may comprise 2,2,2-trifluoroethyl acetate (TFEA), methyl pentafluoropropionate (MPFP), methyl 3,3,3-trifluoropropionate (MTFP), 2,2,2-trifluoroethyl butyrate (TFEB), or a combination thereof. In aspects, the fluorinated ester may comprise TFEA.

The fluorinated ester may constitute, by volume, greater than 5%, optionally greater than or equal to 10%, optionally greater than or equal to 20%, optionally greater than or equal to 30%, or optionally greater than or equal to 35%, and less than or equal to 60%, optionally less than or equal to 50%, or optionally less than or equal to 45% of the organic solvent.

The fluorinated ether is formulated to have exceptional electrochemical stability at high oxidation potentials, good chemical compatibility with the electroactive material of the positive electrode 24, and to provide the electrolyte 28 with high ionic conductivity. The fluorinated ether has the formula (2):

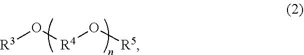

where R³ and R⁵ are each individually a fluorinated or nonfluorinated C₁-C₆ straight-chain or branched-chain alkyl; n is 0 or 1; when present, R⁴ is a fluorinated or nonfluorinated C₁-C₄ straight-chain alkylene; and at least one of R³, R⁴, and R⁵ is polyfluorinated. In aspects, R³ and/or R⁵ each individually may be methyl, fluoroethyl (e.g., perfluoroethyl), fluoropropyl (e.g., per- or poly-fluorinated n-propyl or isopropyl, such as tetrafluoropropyl or perfluoropropyl), fluorobutyl (e.g., per- or poly-fluorinated n-butyl, sec-butyl, isobutyl, or tert-butyl, such as perfluorobutyl or perfluoroisobutyl), fluoropentyl (e.g., per- or poly-fluorinated n-pentyl, 2-methylbutan-2-yl, 2,2-dimetthylpropyl, 3-methylbutyl, pentan-2-yl, or pentan-3-yl, such as hexafluoropentan-2-yl), or fluorohexyl (e.g., per- or poly-fluorinated hexyl, such as 2-methylpentan-3-yl). In aspects where n is 1, R⁴ may be per- or poly-fluorinated ethylene, methylene, propylene, or butylene (e.g., tetrafluorobutylene).

In embodiments, the fluorinated ether may comprise 1,1,2,2-tetrafluoroethyl-2,2,3,3-tetrafluoropropylether (TTE); 1,2-bis(1,1,2,2-tetrafluoroethoxy) ethane (TFE); 2,2,3,3-tetrafluoro-1,4-dimethoxybutane (FDMB); 2-trifluoro-2-fluoro-3-difluoropropoxy-3-difluoro-4-fluoro-5-trifluoropentane (TPTP); 2-trifluoromethyl-3-methoxyperfluoropentane (TMMP); methyl perfluorobutyl ether (MFE) (e.g., methyl nonafluorobutyl ether or methyl perfluoroisobutyl ether); or a combination thereof. In embodiments, the fluorinated ether may comprise TTE.

The fluorinated ether may constitute, by volume, greater than 5%, optionally greater than or equal to 10%, optionally greater than or equal to 20%, optionally greater than or equal to 30%, or optionally greater than or equal to 35%, and less than or equal to 60%, optionally less than or equal to 50%, or optionally less than or equal to 45% of the organic solvent.

The fluorinated carbonate is formulated to promote good solvation of the lithium salt in the electrolyte 28 and to participate in formation of a solid electrolyte interphase (SEI) on surfaces of the negative electrode 22 and/or formation of a so-called “cathode electrolyte interphase” (CEI) on surfaces of the positive electrode 24, which may provide the battery 20 with exceptional cycling stability and capacity retention. The fluorinated carbonate may comprise a cyclic carbonate and/or a linear carbonate. In embodiments, the fluorinated carbonate may comprise fluoroethylene carbonate (FEC); difluoroethylene carbonate (DFEC); bis(2,2,2-trifluoroethyl) carbonate (BFEC); methyl-2,2,2-trifluoroethyl carbonate (FEMC); or a combination thereof. In embodiments, the fluorinated carbonate may comprise FEC.

The fluorinated carbonate may constitute, by volume, greater than 5%, optionally greater than or equal to 10%, or optionally greater than or equal to 15%, and less than or equal to 40%, optionally less than or equal to 30%, or optionally less than or equal to 25% of the organic solvent. In embodiments where the fluorinated carbonate comprises FEMC, the FEMC may constitute, by volume, less than or equal to 10%, optionally less than or equal to 5%, optionally less than or equal to 1%, or optionally less than or equal to 0.1% of the organic solvent.

The volumetric ratio of the fluorinated ester, the fluorinated ether, and the fluorinated carbonate in the organic solvent is selected to provide the electrolyte 28 with a combination of high oxidative stability and high ionic conductivity. A comparison of the oxidation potential and the ionic conductivity of five different organic solvent mixtures is shown in Table 1 below, with mixtures 1, 2, and 3, falling within the scope of the presently disclosed electrolytes. Notably, the oxidation potential and the ionic conductivity values shown in Table 1 are theoretical values calculated based on established parameters and equations, are not based on actual experimental measurements, and are presented herein solely for the purpose of comparison of the organic solvent mixtures and to illustrate how the volumetric ratio of the fluorinated ester, the fluorinated ether, and the fluorinated carbonate in the organic solvent of the presently disclosed electrolytes effects the oxidation potential and the ionic conductivity thereof. In our experiments, the actual measured oxidation potentials and ionic conductivities of mixtures of TFEA:TTE:FEC, FEC:FEMC, and FEC:DEC differed slightly from the values shown in Table 1.

TABLE 1

| | | Theoretical | Theoretical Ionic |
|---|---|---|---|
| Mixture | Volumetric Ratio of | Oxidation Potential | Conductivity |
| No. | Organic Solvents | (V) | (mS/cm) |
| 1 | TFEA:TTE:FEC = | 7.06 | 1.87 |
| | 3:1:1 | | |
| 2 | TFEA:TTE:FEC = | 7.2 | 1.86 |
| | 2:2:1 | | |
| 3 | TFEA:TTE:FEC = | 7.34 | 1.72 |
| | 1:3:1 | | |
| 4 | FEC:FEMC = 1:4 | 7.23 | 0.87 |
| 5 | FEC:DEC = 1:4 | 6.71 | 2.46 |

In embodiments, the volumetric ratio of the fluorinated carbonate to the combined amount of the fluorinated ester and the fluorinated ether [fluorinated carbonate: (fluorinated ester+fluorinated ether)] in the organic solvent may be greater than or equal to 0.9 to 4 (0.9:4) and less than or equal to 1.1 to 4 (1.1:4). For example, in embodiments, the volumetric ratio of the fluorinated carbonate to the combined amount of the fluorinated ester and the fluorinated ether in the organic solvent may be about 1 to 4 (1:4).

The volumetric ratio of the fluorinated ester to the fluorinated ether (fluorinated ester:fluorinated ether) in the organic solvent may be greater than or equal to 1:3, optionally greater than or equal to 1:2, optionally greater than or equal to 1:1.8, optionally greater than or equal to 1:1.6, optionally greater than or equal to 1:1.5, optionally greater than or equal to 1:1.4, optionally greater than or equal to 1:1.2, or optionally greater than or equal to 1:1.1, and less than or equal to 3:1, optionally less than or equal to 2:1, optionally less than or equal to 1.8:1, optionally less than or equal to 1.6:1, optionally less than or equal to 1.5:1, optionally less than or equal to 1.4:1, optionally less than or equal to 1.2:1, or optionally less than or equal to 1.1:1. In aspects, the volumetric ratio of the fluorinated ester to the fluorinated ether in the organic solvent may be about 1:1.

The electrolyte 28 may be substantially free of non-fluorinated organic carbonates, for example, the electrolyte 28 may be substantially free of propylene carbonate (PC), dimethyl carbonate (DMC), diethyl carbonate (DEC), ethyl methyl carbonate (EMC), and combinations thereof.

In embodiments where the organic solvent comprises FEC as the fluorinated carbonate, the electrolyte 28 may be substantially free of additional chemical compounds formulated to participate in formation of a solid electrolyte interphase (SEI) on surfaces of the negative electrode 22 and/or formation of a so-called “cathode electrolyte interphase” (CEI) on surfaces of the positive electrode 24. For example, in embodiments where the organic solvent comprises FEC as the fluorinated carbonate, the electrolyte 28 may be substantially free of vinylene carbonate (VC); vinylethylcarbonate (VEC); ethylene carbonate (EC); propargylmethyl carbonate (PMC); sulfur-containing compounds (e.g., sulfonates, sulfates, sulfones, and sulfites such as ethylene sulfite (ES) and 1,3,2-dioxathiolane-2,2-dioxide (DTD)); vinyl acetate (VA); 2-vinyl pyridine (VP); succinic anhydride (SA); phosphorus-containing compounds; nitriles; and combinations thereof.

The lithium salt is soluble in the organic solvent and provides a passage for lithium ions through the electrolyte 28. The lithium salt may comprise an inorganic lithium salt, an organic lithium salt, or a combination thereof. Examples of lithium salts include lithium hexafluorophosphate (LiPF₆), lithium difluorophosphate (LiPO₂F₂), lithium perchlorate (LiClO₄), lithium tetrafluoroborate (LiBF₄), lithium hexafluoroarsenate (LiAsF₆), lithium bis(trifluoromethanesulfonyl)imide (LiN(CF₃SO₂)₂) (LiTFSI), lithium bis(fluorosulfonyl)imide (LiN(FSO₂)₂) (LiFSI), lithium bis(oxalato) borate (LiB(C₂O₄)₂) (LiBOB), lithium difluoro (oxalato) borate (LiBF₂(C₂O₄)) (LiDFOB), and combinations thereof. In aspects, the lithium salt may comprise LiPF₆. The lithium salt may be dissolved in the organic solvent at a concentration of greater than or equal to 0.5 Molar (M), or optionally greater than or equal to 1 M, and less than or equal to 2 M, or optionally less than or equal to 1.5 M. In aspects, the lithium salt may be dissolved in the organic solvent at a concentration of about 1.2 Molar. The lithium salt may constitute, by weight, greater than or equal to 5%, optionally greater than or equal to 10%, and less than or equal to 20%, or optionally less than or equal to 15% of the electrolyte 28.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be in the form of nonporous metal foils, perforated metal foils, porous metal meshes, or a combination thereof. The negative electrode current collector 30 and the positive electrode current collector 32 may be made of metal or other appropriate electrically conductive material (e.g., carbon). In aspects where the negative electrode current collector 30 and/or the positive electrode current collector 32 are made of metal, the metal may be a substantially pure elemental metal or an alloy of an elemental metal and one or more other metal or nonmetal elements (referred to as “alloying” elements). In aspects, the negative electrode current collector 30 may be made of copper, nickel, or stainless steel, and the positive electrode current collector 32 may be made of aluminum.

### Experimental

Full coin cells including different electrolyte formulations were assembled and evaluated using galvanostatic charge and discharge protocols. All cells included a negative electrode consisting of: an electroactive material consisting of a mixture of 5.5 wt % silicon oxide, graphite, electrically conductive particles, and a polymer binder and having a porosity of about 30%. All cells included a positive electrode consisting of: an electroactive material consisting of Li₂MnO₃, electrically conductive particles, and a polymer binder and having a porosity of about 25%.

A non-fluorinated carbonate-based electrolyte was prepared consisting of: 1.2 Molar LiPF₆ in a mixture of FEC and DEC (volumetric ratio of FEC:DEC=1:4) (FEC-DEC electrolyte). A fluorinated carbonate-based electrolyte was prepared consisting of 1.2 Molar LiPF₆ in a mixture of FEC and FEMC (volumetric ratio of FEC:FEMC=1:4) (FEC-FEMC electrolyte). Electrolytes in accordance with embodiments of the present disclosure were prepared consisting of 1.2 Molar LiPF₆ in a mixture of TFEA, TTE, and FEC (volumetric ratio of TFEA:TTE:FEC=1:2:2) (TFEA-TTE-FEC electrolyte). The as-prepared FEC-DEC electrolyte had a measured ionic conductivity of about 5.2 milliSiemens/centimeter (mS/cm), the as-prepared FEC-FEMC electrolyte had a measured ionic conductivity of about 2.7 mS/cm, and the TFEA-TTE-FEC electrolyte had a measured ionic conductivity of about 3.4 mS/cm.

Cells including the FEC-DEC electrolyte, FEC-FEMC electrolyte, or TFEA-TTE-FEC electrolyte were galvanostatically charged and discharged at 25° C. During formation, the cells were charged at a C/20 rate to 4.6 V. Then, a constant current and constant voltage (CCCV) protocol was used to charge the cells at a constant current using a C/3 charge rate to a potential of about 4.6 V, then constant voltage charge at 4.6 V until the current reached C/20. The cells were subsequently discharged at a constant current using a C/3 discharge rate to 2.0 V.

Cells including the FEC-FEMC electrolyte or the TFEA-TTE-FEC electrolyte had higher capacity retention than cells including the FEC-DEC electrolyte. After about 80 cycles, cells including the FEC-DEC electrolyte had less than about 80% capacity retention. Between cycles 1-300, cells including the FEC-FEMC electrolyte and cells including the TFEA-TTE-FEC electrolyte had substantially similar levels of capacity retention. After about 100 cycles, cells including the FEC-FEMC electrolyte and cells including the TFEA-TTE-FEC electrolyte had relatively high levels of capacity retention (i.e., greater than about 90%), as compared to that of the FEC-DEC electrolyte. After about 200 cycles, cells including the FEC-FEMC electrolyte and cells including the TFEA-TTE-FEC electrolyte both had high levels of capacity retention of greater than about 85%. After about 300 cycles, cells including the FEC-FEMC electrolyte and cells including the TFEA-TTE-FEC electrolyte both had high levels of capacity retention of greater than about 80%.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

As used herein, the phrase at least one of A, B, and C should be construed to mean a logical (A OR B OR C), using a non-exclusive logical OR, and should not be construed to mean “at least one of A, at least one of B, and at least one of C.”

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight and/or volume percentage (%) basis. This may include compositions or materials having greater than 50% X, as well as those having less than 50% X, so long as X is the single largest constituent of the composition or material based upon its overall weight and/or volume. When a composition or material is referred to as being “substantially free” of a substance, the composition or material may comprise, by weight and/or volume, less than 5%, optionally less than 3%, optionally less than 1%, or optionally less than 0.1% of the substance.

What is claimed is:

1. A battery that cycles lithium ions, the battery comprising:
a positive electrode comprising an electroactive positive electrode material; and
an electrolyte infiltrating the positive electrode, the electrolyte comprising:
an organic solvent comprising a fluorinated ester, a fluorinated ether, and a fluorinated carbonate; and
a lithium salt in the organic solvent,
wherein a volumetric ratio of the fluorinated ester to the fluorinated ether in the organic solvent is greater than or equal to 1:3 and less than or equal to 3:1, and
wherein a volumetric ratio of the fluorinated carbonate to the combined amount of the fluorinated ester and the fluorinated ether in the organic solvent is greater than or equal to 0.9:4 and less than or equal to 1.1:4.

2. The battery of claim 1, wherein the electroactive positive electrode material comprises a layered lithium transition metal oxide having an upper cutoff potential of greater than or equal to 4.3 Volts versus Li⁺/Li.

3. The battery of claim 1, wherein the fluorinated ester has the formula (1): 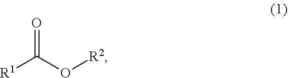
wherein R¹ and R² are each individually a fluorinated or nonfluorinated C₁-C₃ straight-chain alkyl, and
wherein at least one of R¹ and R² is a polyfluorinated ethyl.

4. The battery of claim 3, wherein the fluorinated ester comprises 2,2,2-trifluoroethyl acetate (TFEA), methyl pentafluoropropionate (MPFP), methyl 3,3,3-trifluoropropionate (MTFP), 2,2,2-trifluoroethyl butyrate (TFEB), or a combination thereof.

5. The battery of claim 1, wherein the fluorinated ether has the formula (2): 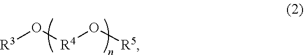
wherein R³ and R⁵ are each individually a fluorinated or nonfluorinated C₁-C₆ straight-chain or branched-chain alkyl;
n is 0 or 1;
R⁴ is a fluorinated or nonfluorinated C₁-C₄ straight-chain alkylene; and
wherein at least one of R³, R⁴, or R⁵ is polyfluorinated.

6. The battery of claim 5, wherein the fluorinated ether comprises 1,1,2,2-tetrafluoroethyl-2,2,3,3-tetrafluoropropylether (TTE); 1,2-bis(1,1,2,2-tetrafluoroethoxy) ethane (TFE); 2,2,3,3-tetrafluoro-1,4-dimethoxybutane (FDMB); 2-trifluoro-2-fluoro-3-difluoropropoxy-3-difluoro-4-fluoro-5-trifluoropentane (TPTP); 2-trifluoromethyl-3-methoxyperfluoropentane (TMMP); methyl perfluorobutyl ether (MFE); or a combination thereof.

7. The battery of claim 1, wherein the fluorinated carbonate comprises fluoroethylene carbonate (FEC); difluoroethylene carbonate (DFEC); bis(2,2,2-trifluoroethyl) carbonate (BFEC); methyl-2,2,2-trifluoroethyl carbonate (FEMC); or a combination thereof.

8. The battery of claim 1, wherein the fluorinated ester constitutes, by volume, greater than 5% and less than or equal to 60% of the organic solvent, the fluorinated ether constitutes, by volume, greater than 5% and less than or equal to 60% of the organic solvent, and the fluorinated carbonate constitutes, by volume, greater than 5% and less than or equal to 40% of the organic solvent.

9. The battery of claim 8, wherein a volumetric ratio of the fluorinated ester to the fluorinated ether in the organic solvent is greater than or equal to 1:1.5 and less than or equal to 1.5:1.

10. The battery of claim 9, wherein the fluorinated ester comprises 2,2,2-trifluoroethyl acetate (TFEA), the fluorinated ether comprises 1,1,2,2-tetrafluoroethyl-2,2,3,3-tetrafluoropropylether (TTE), and the fluorinated carbonate comprises fluoroethylene carbonate (FEC).

11. The battery of claim 10, wherein the electrolyte is substantially free of non-fluorinated organic carbonates.

12. The battery of claim 1, wherein the lithium salt comprises lithium hexafluorophosphate (LiPF₆), lithium difluorophosphate (LiPO₂F₂), lithium perchlorate (LiClO₄), lithium tetrafluoroborate (LiBF₄), lithium hexafluoroarsenate (LiAsF₆), lithium bis(trifluoromethanesulfonyl)imide) (LiTFSI), lithium bis(fluorosulfonyl)imide (LiFSI), lithium bis(oxalato) borate (LiBOB), lithium difluoro (oxalato) borate (LiDFOB), or a combination thereof.

13. The battery of claim 1, wherein the electroactive positive electrode material comprises a layered lithium-rich and manganese-based transition metal oxide represented by the formula Li₁₊ₓMe₁₋ₓO₂, wherein 0<x≤0.33, wherein Me comprises at least one transition metal, and wherein Me comprises, on an atomic basis, greater than 50% manganese (Mn), and wherein the electroactive positive electrode material has an upper cutoff potential of greater than or equal to 4.6 Volts versus Li⁺/Li.

14. The battery of claim 13, wherein the layered lithium-rich and manganese-based transition metal oxide constitutes, by weight, greater than or equal to 90% of the positive electrode.

15. A battery that cycles lithium ions, the battery comprising:
a negative electrode comprising an electroactive negative electrode material;
a positive electrode spaced apart from the negative electrode, the positive electrode comprising an electroactive positive electrode material comprising a layered lithium-rich and manganese-based transition metal oxide represented by the formula Li₁₊ₓMe₁₋ₓO₂, wherein 0<x≤0.33, wherein Me comprises at least one transition metal, and wherein Me comprises, on an atomic basis, greater than 50% manganese (Mn); and
an electrolyte in ion ionic communication with the negative electrode and the positive electrode, the electrolyte comprising:
an organic solvent comprising a fluorinated ester, a fluorinated ether, and a fluorinated carbonate, and
a lithium salt in the organic solvent,
wherein a volumetric ratio of the fluorinated ester to the fluorinated ether in the organic solvent is greater than or equal to 1:3 and less than or equal to 3:1, and
wherein a volumetric ratio of the fluorinated carbonate to the combined amount of the fluorinated ester and the fluorinated ether in the organic solvent is greater than or equal to 0.9:4 and less than or equal to 1.1:4,
wherein the electrolyte is substantially free of non-fluorinated organic carbonates.

16. The battery of claim 15, wherein:
the fluorinated ester comprises 2,2,2-trifluoroethyl acetate (TFEA), methyl pentafluoropropionate (MPFP), methyl 3,3,3-trifluoropropionate (MTFP), 2,2,2-trifluoroethyl butyrate (TFEB), or a combination thereof;
the fluorinated ether comprises 1,1,2,2-tetrafluoroethyl-2,2,3,3-tetrafluoropropylether (TTE); 1,2-bis(1,1,2,2-tetrafluoroethoxy) ethane (TFE); 2,2,3,3-tetrafluoro-1,4-dimethoxybutane (FDMB); 2-trifluoro-2-fluoro-3-difluoropropoxy-3-difluoro-4-fluoro-5-trifluoropentane (TPTP); 2-trifluoromethyl-3-methoxyperfluoropentane (TMMP); methyl perfluorobutyl ether (MFE); or a combination thereof; and
the fluorinated carbonate comprises fluoroethylene carbonate (FEC); difluoroethylene carbonate (DFEC); bis(2,2,2-trifluoroethyl) carbonate (BFEC); methyl-2,2,2-trifluoroethyl carbonate (FEMC); or a combination thereof.

17. The battery of claim 16, wherein a volumetric ratio of the fluorinated ester to the fluorinated ether in the organic solvent is greater than or equal to 1:1.5 and less than or equal to 1.5:1.

18. The battery of claim 15, wherein the fluorinated ester constitutes, by volume, greater than 5% and less than or equal to 60% of the organic solvent, the fluorinated ether constitutes, by volume, greater than 5% and less than or equal to 60% of the organic solvent, and the fluorinated carbonate constitutes, by volume, greater than 5% and less than or equal to 40% of the organic solvent.

19. The battery of claim 15, wherein the layered lithium-rich and manganese-based transition metal oxide has an upper cutoff potential of greater than or equal to 4.6 Volts versus Li⁺/Li, and wherein the electrolyte is chemically stable at operating potentials of greater than or equal to 4.6 Volts versus Li⁺/Li.

20. The battery of claim 15, wherein the electroactive positive electrode material constitutes, by weight, greater than or equal to 90% of the positive electrode.
